(19) United States
(12) Patent Application Publication
(10) Pub. No.: US 2006/0248013 A1
(43) Pub. Date: Nov. 2, 2006

(54) Method and system for distributing media content and measuring user responsiveness thereto

(75) Inventors: Brion Ebert, Easton, PA (US); Oleg Logvinov, East Brunswick, NJ (US)

Correspondence Address: MINTZ LEVIN COHN FERRIS GLOVSKY & POPEO, 666 THIRD AVENUE, NEW YORK, NY, 10017, US

(73) Assignee: Arkados, Inc., North Plainfield, NJ (US)

(21) Appl. No.: 11/404,274

(22) Filed: Apr. 14, 2006

Related U.S. Application Data
(60) Provisional application No. 60/671,426, filed on Apr. 14, 2005.

(51) Int. Cl. G06Q 99/00

(52) U.S. Cl. 705/51

(57) ABSTRACT

The trend toward moving to digital content is progressing and expanding every day. With that trend comes the availability of a multitude of content from content sources through, for example, the public Internet. A method and system for content distribution are provided that allow content providers to customize the content that is (i) distributed to content rendering devices and/or (ii) suggested for download or purchase by users of the rendering devices, based on user responses and interactions resultant from the content. This interaction allows for the most likely and desired content to be available to the user for play or purchase.

### CROSS REFERENCE TO RELATED APPLICATION

This claims the benefit of U.S. Provisional Application No. 60/671,426 filed Apr. 14, 2005, and titled “Method and System for Content Distribution that can Provide a Measured User Response”, which is hereby incorporated by reference herein in its entirety.

### FIELD OF THE INVENTION

Embodiments of the invention relate to the distribution of content, such as audio, video and/or other data, over conventional mediums, such as cable, DSL, wireless, or powerline (electric power conveying media utilized as a local communications network). More particularly, embodiments of the invention relate to utilizing one or a combination of these networks to create a content distribution system in which the content and/or other options provided to an end-user (e.g., a list of content available for download or purchase) are customized based on user responsiveness and interaction resultant from the content rendering.

### BACKGROUND OF THE INVENTION

Multimedia distribution is experiencing a shift from old-fashioned analog signals into digital distribution. Kevin Carton from PricewaterhouseCoopers' Entertainment & Media Practice opines that “By 2010, virtually all entertainment and media will be in a digital format.” According to the report “Music Retailing: Using Digital Music to Strengthen Customer Relationships”, “Digital music sales will surpass online CD sales by the end of 2008.” Moreover, in a report titled “Media Networking 2005: The Networked Living Room Becomes a Reality”, InStat cites the following important trend: total media networking connections in homes will grow from over 50 million in 2005 to over 200 million in 2009, a 29% compound annual growth rate. This shift creates the demand for new products that incorporate digital technologies supporting such functions as communication and media rendering.

These sources all point to a continuing shift to digital content, and to digital content rendering devices. More specifically, these trends point to the growing need for, and indeed the continuing proliferation of, digital content sources, digital content distribution networks and mediums, and digital content rendering devices such as digital music players, smart phones, or other Internet appliances. However, despite the eventual proliferation and availability of digital content and digital content rendering devices, it does not necessarily follow that digital content providers will be able to provide, or that an end-users of digital content rendering devices will be able to locate, digital content that correlates with the interests and/or other characteristics of the end-users.

In view of the foregoing, it would be desirable to provide systems and methods for distributing media content and measuring user responsiveness thereto.

### SUMMARY OF THE INVENTION

In accordance with various embodiments of the present invention, methods and systems are provided for distributing media content (e.g., audio, video, graphics, and/or data) and measuring user responsiveness thereto. In one embodiment, media content is “pushed” (i.e., forced delivery) to a digital content rendering device of an end-user such as, for example, inserted into a playlist of the digital content rendering device. Thereafter, the end-user's response to the digital content is measured by, for example, determining whether the end user skipped, deleted, increased or decreased volume, and or replayed the digital content upon the rendering of the content. Preferences of the end user are determined from the end-user's response. The preferences may be incorporated into a profile for the end user, which may be updated whenever new preference data for the end-user is received. Based on the end-user's preferences, the end-user may be presented with media content that matches the preferences (e.g., additional content may be “pushed to the end-user) and/or the end-user may be presented with one or more options to download or purchase media content matching the preferences. In a preferred embodiment, the media content and user response data are transmitted over the public Internet. As such, the digital rendering device (Internet Appliance) may be capable of connecting to or otherwise communicating with the Internet (e.g., communicating information to/from the Internet through an intermediary device such as a personal computer). Other embodiments of the present invention are described in the following detailed description.

### BRIEF DESCRIPTION OF THE DRAWING

Other objects and advantages of the present invention will be apparent from the following detailed description of the presently preferred embodiments, which description should be considered in conjunction with the accompanying drawing in which:

FIG. 1 depicts a content distribution method and system that allows for content distribution, user feedback, and account management.

### DETAILED DESCRIPTION OF THE INVENTION

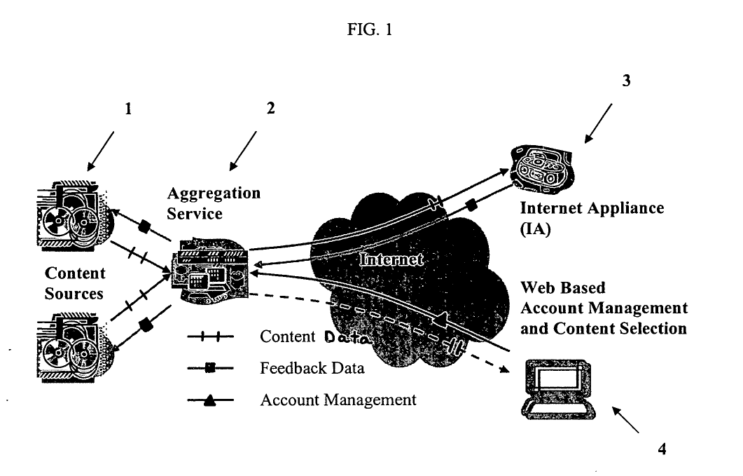

FIG. 1 shows an embodiment of an implementation of the present inventive concept that would be typical for today's networks and infrastructure. This implementation includes one or more Content Sources 1 configured to transmit digital content to, and/or receive feedback data from, Aggregation Service 2 over a suitable communications path (e.g., via the Internet). Aggregation Service 2 is configured to transmit digital content to and receive feedback data from an Internet Appliance 3 and to transmit information regarding media content to, and receive account management data from, a Web Based Account Management and Content Selection functionality 4.

Examples of suitable Content Sources 1 include Internet radio stations that may be subscription based or free (such as Shoutcast), video-on-demand providers such as MovieLink, or any other Internet based content provider (e.g., iTunes). Aggregation Service 2 may use its Internet portal to link to these content providers to retrieve, combine, categorize, and format the content so that it can be displayed and distributed to an Internet Appliance 3. The Internet Appliance could be a digital music player, a smart phone, or any other Internet enabled device (e.g., a personal computer (PC) or an iPod configured to communicate either directly with the Internet or indirectly via a PC). Feedback from the Internet Appliance (e.g., end-user responses to media content) may be transmitted back to the Aggregation Service (e.g., directly from the Internet Appliance or indirectly such as via an associated PC). The Aggregation Service may or may not massage or manipulate the feedback data to make it presentable to the Content Sources, whereby the most suitable choices for additional content are determined. Requests for such additional content may be transmitted to the Content Sources. Alternatively or additionally, the Aggregation Service may provide information regarding digital content to Web Based Account Management and Content Selection functionality 4, such that subscription based content can be tracked and properly charged for, account information can be properly managed, and/or functionality 4 can provide the end-user with option(s) to download or purchase media content (e.g., presenting the end-user with a list of available content the next time the end-user accesses the end-user's account via functionality 4). In some embodiments, one or more Content Sources 1 may be operative to communicate with Internet Appliance 3 and/or functionality 4 without the need for a separate Aggregation Service.

A more detailed description is now provided in order to facilitate a further understanding of aspects and embodiments of the invention. The following example is not intended to be limiting with respect to the scope of the present invention, and various alterations and modifications will be apparent to one of ordinary skill in the art. In one embodiment, the Internet Appliance may be a Digital Music Player (DMP) that is operative to receive digital audio streaming content over the Internet and that can support one or more (e.g., all) of the following functions: render audio streams from Internet radio stations, render files stored on local computers, and render the content provided by a service provider/recording company.

In this example each user can be associated with a specific DMP device (such as an iPod) during the initial setup (e.g., registration) of the device. Basic user related information can be collected (age, sex, occupation, location, preferred media genre(s), etc.), transmitted, and may be stored in a user database at the Aggregation Service, or may be sent on and stored in a user database at the Content Source provider. This information may be used to form an initial user profile. Additionally, when the user requests audio streams from an Internet radio station, or a song or other media from a service provider, recording company, or other online source, information regarding one or more of the type, genre, title, artist, other characteristic, etc. may also be stored in the user database at the time the request is made. As the amount of this information increases, a simple search through the information stored in the user database can be performed (manually or by an automated process) to look for similarities in the type or genre of the radio stations or songs that have been requested, and the preferences of the user can be “learned”. Based on these learned preferences, the Aggregation Service can request, or the Content Sources can provide, additional suggestions for audio content. These suggestions can then be sent to a user's DMP, either each time the user connects the device to the service, or at scheduled intervals when the device is connected. Alternatively or additionally, one or more of these suggestions can be presented to the user (e.g., in list format) in an interface from which the user can select to download or purchase the suggested content.

Regardless of what is currently “on” the service provider can push “non-scheduled” content into the active playlist of the DMP. Such non-scheduled content can be pushed into the active playlist at any suitable time and with any suitable frequency. Digital content can be delivered to a the DMP using any suitable approach such as, for example, streaming the digital content to the DMP (e.g., in real time, when the digital content is the current selection in the playlist). In another embodiment, the digital content can be downloaded to the DMP in advance of its rendering to the end-user. User response can be measured as the reaction to the “non-scheduled” content (delete from playlist, skip, repeat, volume up/down, etc.), and this information can be transmitted and stored in the user's database (e.g., transmitted immediately, at scheduled intervals, or at any other suitable time). For example, the DMP may include any suitable hardware, software, or combination thereof capable of receiving the digital content, inserting the digital content into the end-user's playlist, monitoring the end-user's response to the inserted digital content, and transmitting the response information (e.g., for evaluation). Based on this information, the preferences for this user can be “fine tuned” (or established initially if no other preferences have been determined) to try to determine the best sources of audio content for future suggestions. For example, if a user turns up the volume, or repeats a selection, the parameters of the selection may be given a higher value, or placed at the top of the user preferences list. Vice versa, if the user skips over a selection, then the parameters of the selection may be given a lower priority, or placed at the bottom of the user preferences list. In an embodiment, reports of the end-user's preferences can be generated and, for example, sold to third parties (e.g., marketing agencies).

The historical data of the user database can also include the following: content of the active playlists, listening preferences, and other general parameters. This information can be analyzed by the Aggregation Service to determine general preferences for each user, if the user database is located in the Aggregation Service. The service could then also connect to other digital content sources that may be similar, or offer similar sources of content, to expand the list of suggestions for each user. This could allow for an increased variety of suggestions that can be provided to the user (e.g., sent to a user's DMP) at the next exchange of data.

It can be seen from this example that there are a variety of methods and options that can be employed to measure a user's response to distributed content. The invention allows a service or content provider to offer additional features to a user, which services may or may not be free of charge (e.g., subsidized). In this embodiment, a service or content provider can push paid sources of content as a way of increasing its revenue, possibly directly, or through agreements with other paid content sources. This model of content distribution can also allow for “free” (or subsidized) devices and/or service for users, as the cost of such devices and/or service can be sponsored by the service or content provider.

The handling of paid content and account management can be done by the Web Based Account Management and Content Selection functionality that may reside locally (for example an application stored on a local home computer), or may reside at the Aggregation Service or another suitable device or location. In either case, it would also be possible for a DMP or other Internet appliance to interface directly to this functionality to allow for immediate download of paid content. This functionality is applicable not only for audio sources, but also video sources of paid content. Smart phones or other types of advanced Internet appliances could also receive digital video content seamlessly and immediately, which could be yet another feature offered by a service or content provider. Thus it is seen that systems and methods are provided for distributing media content and measuring user responsiveness thereto. Although particular embodiments have been disclosed herein in detail, this has been done by way of example for purposes of illustration only, and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implementable, at least in part, using a computer system, it will be appreciated that a computer program for implementing at least part of the described methods and/or the described systems is envisaged as an aspect of the present invention. The computer system may be any suitable apparatus, system or device. For example, the computer system may be a programmable data processing apparatus, a general purpose computer, a Digital Signal Processor or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits.

Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disc or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A method for distributing digital content to an end-user associated with a digital rendering device, said method comprising:
selecting digital content for forced delivery to said digital rendering device; and
determining a response of said end-user to said digital content.

2. The method of claim 1, wherein said selecting said digital content comprises forcing said digital content into a playlist of said digital rendering device.

3. The method of claim 2, further comprising:
storing preferences of said end-user,
wherein said forcing said digital content into said playlist comprises forcing digital content that matches said preferences into said playlist.

4. The method of claim 2, wherein said determining a response comprises determining whether said end-user provides a response selected from the group of responses of skipping, deleting, increasing volume of, decreasing volume of, and replaying the digital content.

5. The method of claim 1, further comprising selecting digital content for future delivery to said digital rendering device based on said response.

6. The method of claim 1, further comprising displaying to said end-user, based on said response, information regarding digital content suggested for download or purchase by said end-user.

7. The method of claim 1, further comprising delivering said digital content to said end-user.

8. A method for distributing digital content to an end-user associated with a digital rendering device, said method comprising:
forcing digital content comprising audio into a playlist of said digital rendering device;
determining a response of said end-user to said digital content, wherein said response is selected from the group of responses of skipping, deleting, increasing volume of, decreasing volume of, and replaying the digital content;
based on said response, determining a preference of said end-user; and
selecting digital content based on said preference for delivery to the digital rendering device or suggestion to the end-user in an interface display.

9. A system for distributing digital content, said system comprising:
a digital rendering device associated with an end-user;
a source of digital content; and
an aggregation service configured to select digital content from said source for forced delivery to said digital rendering device,
wherein said digital rendering device is configured to determine a response of said end-user to said selected digital content and provide said response to said aggregation service.

10. The system of claim 9, wherein said aggregation service is configured to force said selected digital content into a playlist of said digital rendering device.

11. The system of claim 10, further comprising:
memory for storing preferences of said end-user,
wherein said aggregation service is configured to force digital content that matches said preferences into said playlist.

12. The system of claim 10, wherein said digital rendering device is configured to determine whether said end-user provides a response selected from the group of responses of skipping, deleting, increasing volume of, decreasing volume of, and replaying the digital content.

13. The system of claim 9, wherein said aggregation service is further configured to select digital content for future delivery to said digital rendering device based on said response.

14. The system of claim 9, further comprising an interface operative to display to said end-user, based on said response, information regarding digital content suggested for download or purchase by said end-user.

15. The system of claim 9, wherein said aggregation service is further configured to deliver said digital content to said end-user.
